(19) United States
(12) Patent Application Publication
(10) Pub. No.: US 2004/0263489 A1
(43) Pub. Date: Dec. 30, 2004

(54) Method and a system for performing a selection and an electronic device

(75) Inventor: Jukka Wallenius, Helsinki (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/861,115

(22) Filed: Jun. 4, 2004

(30) Foreign Application Priority Data
Jun. 4, 2003 (FI) 20035084

(51) Int. Cl. G09G 5/00

(52) U.S. Cl. 345/173

(57) ABSTRACT

In a method, device, system, and program for performing a selection on a touch-sensitive touch panel, at least one selection area is determined and shown on a display. Two or more touch points are determined on the touch panel, and by means of these touch points, at least one selection coordinate data is determined. The determined at least one selection coordinate data is compared to said at least one selection area.

### CROSS-REFERENCE TO RELATED APPLICATIONS

This application claims priority under 35 USC §119 to Finnish Patent Application No. 20035084 filed on Jun. 4, 2003.

### FIELD OF THE INVENTION

The present invention relates to a method for performing selection with a touch-sensitive touch panel, in which method at least one selection area is determined and said at least one selection area is shown on a display. In addition, the invention relates to an electronic device, which comprises a touch-sensitive touch panel for performing a selection, means for determining at least one selection area, and a display arranged in connection with the touch panel for displaying said at least one selection area. The invention also relates to a system, which comprises a touch-sensitive touch panel for performing a selection, means for determining at least one selection area, and a display arranged in connection with the touch panel for displaying said at least one selection area. In addition, the invention relates to a program, which comprises machine-executable program commands for performing a selection with a touch-sensitive touch panel, for determining at least one selection area, and for showing said at least one selection area on a display.

### BACKGROUND OF THE INVENTION

Electronic devices are known, wherein there is a touch panel or a corresponding device, which senses a touch and determines the touch point. This type of a touch panel is typically used placed on top of a display terminal, in which case this type of an arrangement is also referred to as a touch display. The user of the electronic device can thus perform selection procedures and the like by touching the surface of the touch panel at an appropriate point. The information shown on the display can thus be used in selecting the touch point. For example, selection areas are formed on the display, in connection with which areas information connected to the selection area is displayed. This information can be a text that discloses which procedure is achieved in the electronic device by touching the selection area in question. The information can also be image information, such as a symbol, which discloses a procedure.

Nowadays it is possible to determine selection areas in a moving image as well, by touching which the selections can be made. The target use can be, for example, an advertisement, wherein by touching the product being advertised, it is possible to make, for example, product data or a subscription form visible. On small displays it can be difficult to select the correct object, especially if the object is moving. Also, the user may be slightly late in pointing to the object if he/she does not immediately notice the object to be pointed to.

The functions included in said selection areas can also be so-called hyperlinks, i.e. touching a selection area starts a hyperlink, which usually means that the object pointed to by the hyperlink in question is activated in the electronic device, i.e. information connected to the object pointed to by the hyperlink is shown on the display of the electronic device. The hyperlink can be, for example, a reference to some document, in which case activating the link starts loading the document into the electronic device, if necessary, and starts showing the document on the display of the electronic device. The hyperlink can also be a reference to some www-page, in which case this page is attempted to be loaded into the electronic device and its contents are shown on the display. A hyperlink can be disclosed, for example, in a text form, as a symbol, as a combination of these, or in some other appropriate manner.

It is possible to use the touch panel, for example, for drawing as well, in which case the touch point is sensed on the touch panel, as well as its movement on the surface of the touch panel, in which case, for example, dots or a uniform line is drawn on the display at the points according to the touch point and its movement, in which case the drawer receives substantially instant feedback.

By means of a touch panel, it is also possible to implement functions according to a pointer device, such as a so-called computer mouse. Thus the user can, instead of a conventional pointer device or in addition to it, perform selection functions by touching the touch panel at appropriate places, such as at the abovementioned selection areas.

A problem in systems according to prior art, wherein the touch panel is used e.g. for performing selection functions, is e.g. that the selection areas can be close to each other, in which case an exact touching of the selection area is not easy and the finger touching the touch panel can hide even more selection areas from the user's view. This can cause erroneous selections. Said selection areas can even be moving, in which case touching the desired selection area is even more difficult than before and the probability of erroneous selections increases.

### SUMMARY OF THE INVENTION

It is an aim of the present invention to provide a method and a system for performing a selection in such a manner that the possibility of erroneous selections is smaller than when using solutions according to prior art. The invention is based on the idea that touch information composed of several touch points is analyzed, and on the basis of that, the aim is to determine a selection coordinate or a group of selection coordinates, which are used in determining the selection point. In the analysis, it is possible to, for example, establish a center of gravity determined by several touch points, the center of the touch areas, the center of mass, or etc. data. The data can also be a group of coordinates, such as a line segment between two points, in which case this group of coordinates is used in establishing what the selection point or selection area desired by the user is. To put it more precisely, the method according to the present invention is primarily characterized in that two or more touch points are established on the touch panel, and by means of these touch points at least one selection coordinate data is determined, in which case the determined at least one selection coordinate data is compared to said at least one selection area. The electronic device according to the present invention is primarily characterized in that, in addition, the electronic device comprises means for establishing two or more touch points on the touch panel, means of determining at least one selection coordinate data by means of these touch points, and comparison means for comparing the determined at least one selection coordinate data with said at least one selection area. The system according to the present invention is, in addition, primarily characterized in that the system also comprises means for establishing two or more touch points on the touch panel, means of determining at least one selection coordinate data by means of these touch points, and comparison means for comparing the determined at least one selection coordinate data with said at least one selection area. The program according to the present invention is, in addition, primarily characterized in that the program also comprises machine executable program commands for establishing two or more touch points on the touch panel, for determining at least one selection coordinate data by means of these touch points, and for comparing the determined at least one selection coordinate data with said at least one selection area.

The present invention shows remarkable advantages over solutions of prior art. By determining the selection coordinates according to the invention it is possible to improve the selection accuracy e.g. because the user's finger does not have to point exactly at the desired point, in which case the finger does not hide the selection areas important from the point of view of selection. By means of the solution according to the invention it is easier to focus the selection also on moving selection areas. In addition, here it is possible to use a time window as an aid, in which case the selection areas coming to the area determined by the selection coordinates during a time determined by the time window are selected. Thus, the user does not have to time the touch as accurately as in the solution according to prior art. When using a method according to an advantageous embodiment of the invention, it is easier for the user to also perform the transfer of a selection area to some other place, because the user can, in a manner of speaking, grab the selection area to be moved with fingers, after which the user can perform the transfer of the selection area by moving his/her fingers along the surface of the touch means. In this embodiment either, fingers do not hide the place wherein the selection area at a certain time moves, which makes it easier to focus the moved selection area to a desired point.

### DESCRIPTION OF THE DRAWINGS

In the following, the invention will be described in more detail with reference to the appended drawings, in which

FIG. 1 shows an electronic device according to a preferred embodiment of the invention in a simplified block diagram;

FIG. 2 shows an example of information shown on the display, wherein there are selection areas;

FIG. 3a shows a touch pattern;

FIG. 3b shows one selection coordinate determined on the basis of the touch pattern according to FIG. 3a; and

FIG. 3c shows a group of selection coordinates determined on the basis of the touch pattern according to FIG. 3a.

### DETAILED DESCRIPTION OF THE INVENTION

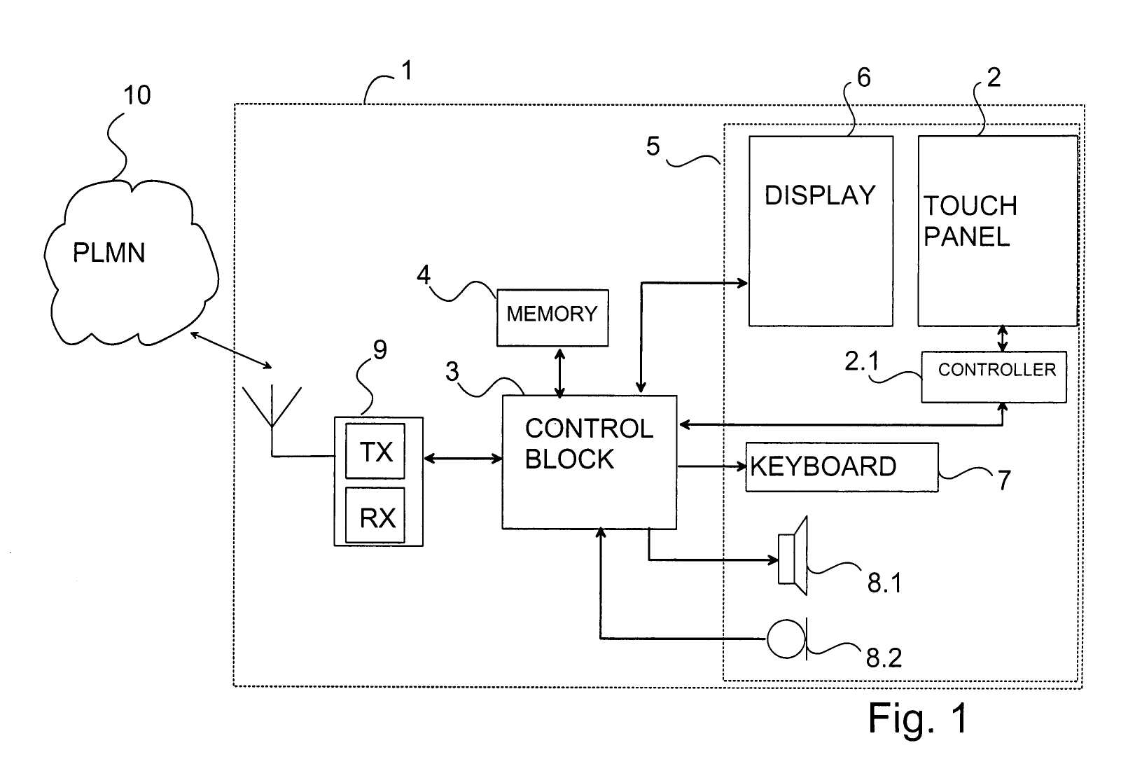

The electronic device 1 according to an advantageous embodiment of the invention shown in FIG. 1 comprises e.g. a touch panel 2 for sensing touches. The touch panel 2 is at least partly transparent and it is placed on top of the display 6.

In this context, it should be mentioned that in this description a touch does not refer solely to a situation, wherein the touching means touches the surface of the touch panel, but the touch can in some cases also be sensed by a proximity sensor in a situation, wherein the touching means is close enough to the surface of the touch panel 2 to be sensed, without actually touching it. In addition, there can be e.g. a transparent protective film on the surface of the touch panel 2, in which case a touch can be performed on this protective film or the touching means is close enough to it and the touch panel 2 can sense the touch. This type of a touch panel requiring a non-physical touch is generally carried out by a capacitive and/or an optic principle.

A touch panel controller 2.1 is typically arranged in connection with the touch panel 2, in which controller the necessary procedures are carried out in order to control the function of the touch panel and to detect touches. The controller 2.1 of the touch panel performs advantageously the formation of the coordinates of the touch point and transmitting them e.g. to the control block 3 of the electronic device. On the other hand, the procedures necessary for controlling the function of the touch panel 2 and for sensing a touch can in some applications be performed also in the control block 3 of the electronic device 1, in which case an individual controller 2.1 for the touch panel is not required.

The touch panel 2 used in connection with this invention senses at least two substantially simultaneous touches. In implementing this type of a touch panel 2, it is possible to use many different techniques, of which it is possible to mention touch panels based on optical identification, capacitive touch panels and resistive touch panels as non-limiting examples. The touch-sensitive area of the touch panel 2 is thus advantageously formed as a matrix, in which case each matrix element can sense the touch. The touch points can be established e.g. by examining each matrix element individually, or by going through the matrix elements either row-by-row or column-by-column. Thus, it is examined from each row and column, which element contains a touch possibly sensed. After this, the next row/column is advantageously examined. The examination is continued until the entire matrix has been gone over and the function can start again by examining the first row/column. In view of the present invention, however, the principle of how the touch points are sensed is not significant.

There is a control block 3 in the electronic device 1, with which controlling the functions of the electronic device 1 is performed in a manner known as such. In the control block 3, it is also possible to perform analyzing and other calculation and inference procedures according to the present invention in a manner disclosed later in this description.

Memory 4 is also arranged to the electronic device 1 in order to store, for example, data required in the function of the electronic device 1, as well as the program codes of the control block. In the user interface 5 (UI) of the electronic device, to which the touch panel 2 can also be considered to belong, there is a display 6, a keyboard 7, and audio means 8, such as an earpiece/a speaker 8.1 and a microphone 8.2. With the communication means 9, the electronic device 1 can communicate with a communication network 10, such as a Public Land Mobile Network (PLMN), and/or some other electronic device equipped with corresponding communication means (not shown), in a manner known as such.

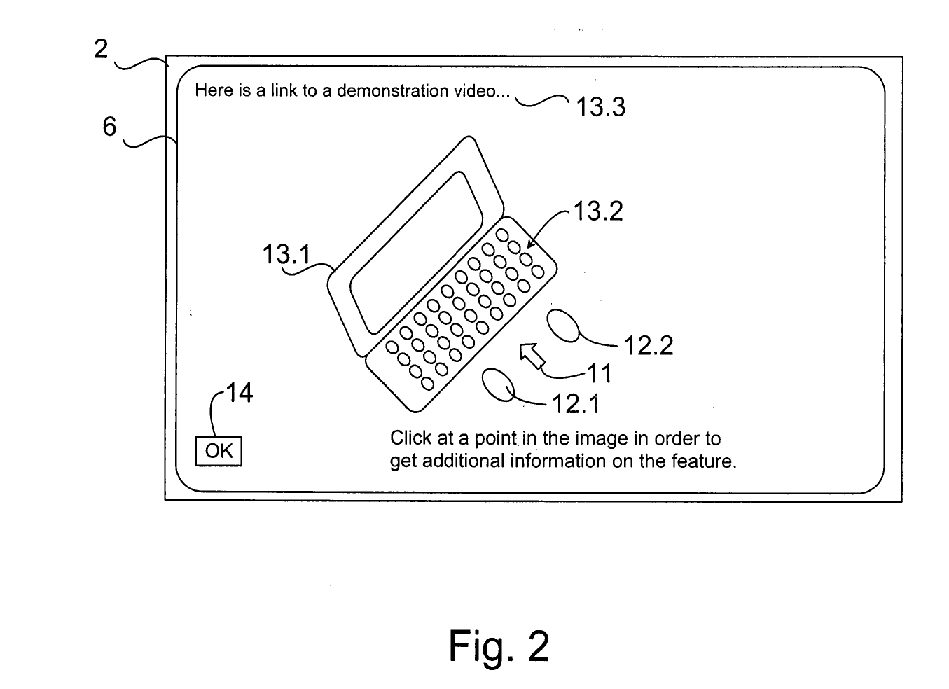

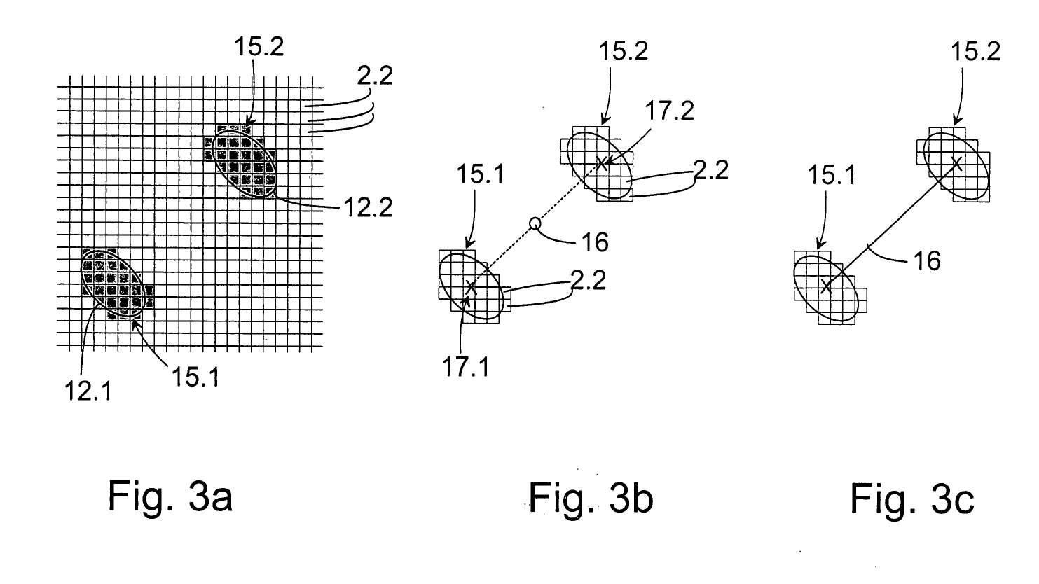

In the following, the operation of a method according to an advantageous embodiment of the invention in the electronic device 1 will be described with reference to the appended FIGS. 2 and 3a to 3c. FIG. 2 shows an example of the information displayed on the display 6 of the electronic device 1, wherein selection options are included. A touch panel 2 is placed on top of the display 6, in which case the user can e.g. with fingers touch the touch panel 2. In this example situation, a group of links 13 is shown on the display, of which it is possible to receive additional information and/or to change another image, video, or the like to the display 6. With the first link 13.1 the user can, for example, receive additional information on the device shown on the display, other links 13.2 are connected, for example, to receiving additional information on the details of the device, such as the keys, and the third link 13.3 in this example starts showing another video on the display 6,

The example in FIG. 2 presents a touch situation of two fingertips, in which case two touch areas 12.1, 12.2 are sensed in the electronic device 1, and selection coordinates are determined on the basis of them. On the display 6, a pointer 11, such as an arrow, is presented at the selection coordinates, on the basis of which pointer the user can, in order to move the pointer 11, move one or more touch points, if necessary. New selection coordinates are determined in the electronic device 1 and they are updated to correspond to the location of the pointer 11. The pointer 11 is not, however, necessarily presented in all situations. Instead of presenting the pointer, it is possible to, for example, draw a line segment between the touch areas, in which case the link cut by the line segment becomes a different colour when it can be selected.

At that stage when the pointer 11 is at the correct selection point, the user can perform the activation of this selection, e.g. getting additional information on the properties of the device shown on the display, such as some key. The electronic device 1 can be informed of the activation of the selection in several different manners. For example, a selection key 14 is shown on the display of the electronic device 1, in which case the user can, for example, with a free finger touch this selection key 14, after which the electronic device 1 senses the touch point and the selection coordinates are determined. In this alternative, this third touch point is, thus, not used together with other touch points 12.1, 12.2 in calculating the centers of gravity of the touch points, but this touch is handled individually. In some situations the user can, however, want to use three or even more fingers in determining the selection coordinates. Thus, it is possible to act, for example, in such a manner that if the user, within a relatively short time, touches the touch panel 2 with several fingers, all the touches are assumed to be connected to determining the selection coordinates. If the user later touches the surface of the touch panel with some free finger, it can be assumed that this touch is handled individually. As yet an additional criterion it is possible to use the fact whether some selection function is determined for this additional touch point. If this type of a selection function is determined, such as, for example, the selection key 14 shown in FIG. 2, it is assumed that the user wants this touch to be handled individually. In other cases this separate touch can also be taken along in determining selection coordinates, or it can be left unnoticed altogether. Another possibility for carrying out the activation of selection is that a touch panel 2 is used, wherein there is also means sensing the contact pressure (not shown). Thus, a typical relatively light touch is interpreted as determining selection coordinates and a heavier stroke is interpreted as activating the selection. A heavier stroke can be performed with one or more fingers used in the selection, or with other selection means.

FIG. 3a shows a selection pattern 15. In this example, the selection pattern 15 is formed of two touch areas 15.1, 15.2 created by two fingers. These touch areas are determined by means of a group of selection points from the information provided by the touch panel 2. Such touch elements 2.2 of the touch panel 2, wherein the touch is detected, are shown darker in FIG. 3a. In this example, the detection accuracy (resolution) of touches is relatively dense, but it is clear that the invention can be applied also in connection with such touch panels, wherein the resolution differs from the example presented here.

From the controller 2.1 of the touch panel, data on the coordinates of each touch point is transmitted to the control block 3 of the electronic device 1, wherein the determination of selection coordinates is performed. In an embodiment, wherein only one selection coordinate data (x, y coordinate) is determined, the operation is advantageously as follows. Different touch areas 15.1, 15.2 are determined from the touch points, for example, by comparing which touch points are adjacent. Some value is calculated from these areas, advantageously a center of gravity, which is selected as a coordinate representing the area (marked with reference numbers 17.1, 17.2 in FIGS. 3b and 3c). When the coordinates of all touch areas are determined, it is possible to calculate the actual selection coordinate data 16 on the basis of these coordinates, which data is used in carrying out the procedure caused by the touch. On the basis of the selection coordinate data, for example, the pointer on the display 6 is moved and the selection of an object is performed, if it is a question of activating a selection.

In an embodiment according to FIG. 3c, the selection coordinate data 16 comprises a group of selection coordinates. This group is, for example, a line segment between the centers of gravity of two touch areas. Thus, this line segment is shown on the display 6 and the selection is targeted at those targets available for selection, which are along the line segment in a position to be activated as the selection. If in this embodiment there are more than two touch areas, the centers of gravity of the touch areas, or the like, determine the area. Thus, this area functions as the selection coordinate data, i.e. the selection is aimed substantially at the selectable targets inside the area.

All the targets that can be selected and that comply with the selection criteria are not, however, necessarily selected. For example, if at each moment the purpose is to select only one target, it is possible to function in the following manner in a method according to an advantageous embodiment of the invention. It is examined whether there are any selection areas at the point (or area) determined by the selection coordinates. If there is only one selection area of this type, it is selected. If there is more than one selection area, it is determined, for example, which of the selection areas best corresponds to the selection coordinates. This can be determined, for example, by calculating the centers of gravity of the selection areas and by comparing them with the selection coordinates. That selection area, whose center of gravity is the closest to the selection coordinates or the line segment, area or the like determined by the selection coordinates, is selected. If there are no selection areas within the point or the area determined by the selection coordinates, it is possible to establish which of the selection areas is the closest to the selection coordinates or the line segment, area or the like determined by the selection coordinates. Thus, the closest selection area is selected.

In a method according to another advantageous embodiment of the invention, it is possible to select more than one selection area at a time. Thus, the selection criteria can be which selection areas are within the area determined by the selection coordinates. In addition, it is possible to determine a limit value for the distance, i.e. such selection areas, which are closer to the point, line segment, area or the like determined by the selection coordinates than this limit value, are selected.

The control block 3 has data on the information shown on the display, such as the hyperlinks and other possible targets that can be selected (selection areas). The control block has data also on the coordinates of these selection areas, in which case, by comparing the selection coordinate data with the coordinate data of the selection areas it is established which selection areas are in the point determined by the selection coordinate data, and can thus be selected. The selection areas can be, for example, temporal or spatio-temporal hyperlinks. Temporal hyperlinks are shown on some point of the display 6 for a limited time, and their location can change as a function of time. The temporal hyperlinks disappear from the display at some point if they are not selected. Showing the spatio-temporal hyperlinks on the display 6 can depend on, e.g. the information shown on the display at each time. A temporally limited display time can be connected also to the spatio-temporal hyperlinks. The hyperlinks do not need to be in a steady place either, but they can be moving. As an example of this can be mentioned hypervideo, wherein objects move on display and a hyperlink is connected to these objects. Thus, by selecting such an object, the function connected to the object is activated, e.g. some other video is started, a help text is presented, etc.

In the method according to another advantageous embodiment of the invention, it is, in addition, possible to determine a time window. Thus, the selection can focus also on such moving selection areas, which hit the point determined by the selection coordinates within the time determined by this time window. The time calculation of the time window is started in connection with determining the selection coordinates, preferably after the selection coordinates are determined. The end of determining the selection coordinates can be concluded, for example, in such a manner that the user lifts his/her finger or other pointer means off the touch display, or when the coordinate data remain constant for a certain time, or by touching the selection key 14 described earlier in this description, or by a pressure-sensing method.

By means of the method according to the invention it is possible to make the selection of especially moving and small objects easier by means of the touch panel 2. The comfort of use of the electronic device 1 can thus be improved. The user can also, in a manner of speaking, grab the object he/she desires by touching the edge areas of the object with several fingers, which e.g. decreases the possibility of erroneous selections.

It shall be evident that the present invention is not limited solely to the above-presented embodiments but it can be modified within the scope of the appended claims.

1. A method for performing a selection with a touch-sensitive touch panel, the method comprising:
determining at least one selection area,
showing said at least one selection area on a display,
establishing two or more touch points on the touch panel,
determining by means of these touch points at least one selection coordinate data, and
comparing the determined at least one selection coordinate data to said at least one selection area.

2. The method according to claim 1, comprising determining for each touch point a coordinate data representing the touch point, and determining at least one selection coordinate data on the basis of each coordinate data representing a touch point.

3. The method according to claim 1, comprising using a line segment connecting touch points as said at least one selection coordinate data.

4. The method according to claim 1, comprising using as said at least one selection coordinate data an area, which is determined by means of the coordinates of three or more touch points.

5. The method according to claim 1, comprising determining the center of gravity of each touch point, and using the determined centers of gravity in determining said at least one coordinate data.

6. The method according to claim 1, comprising examining, whether there are selection areas in the point determined by the selection coordinate data, in which case
if there are no selection areas in the point determined by the selection coordinate data, it is established which selection area is the closest, and that is selected,
if there is one selection are in the point determined by the selection coordinate data, that is selected, and
if there are several selection areas in the point determined by the selection coordinate data, it is established which of these selection areas is the closest to the point determined by the selection coordinate data, and that selection area is selected.

7. The method according to claim 1, wherein at least one selection area is moving.

8. The method according to claim 7, comprising determining a time window, and when the selection area comes to the point determined by the selection coordinates during said time window, selecting this selection area.

9. The method according to claim 1, wherein at least one selection area is a temporal or spatio-temporal hyperlink, the selection of which activates said hyperlink.

10. An electronic device, which comprises a touch-sensitive touch panel for performing a selection, means for determining at least one selection area, and a display arranged in connection with the touch panel for showing said at least one selection area, the electronic device, in addition, comprising means for establishing two or more touch points on the touch panel, means for determining at least one selection coordinate data by means of these touch points, and comparison means for comparing said at least one selection coordinate data to said at least one selection area.

11. The electronic device according to claim 10, comprising means for determining a coordinate date representing the touch point for each touch point, and for determining said at least one selection coordinate data on the basis of each coordinate data representing a touch point.

12. The electronic device according to claim 10, comprising means for determining the center of gravity of each touch point, in which case the determined centers of gravity are arranged to be used in determining said at least one selection coordinate data.

13. The electronic device according to claim 10, comprising means for showing at least one moving selection area.

14. The electronic device according to claim 13, comprising means for determining a time window, in which case when the selection area comes to the point determined by the selection coordinates during said time window, this selection area is arranged to be selected.

15. The electronic device according to claim 10, the touch panel comprising touch elements arranged as a matrix.

16. A system, which comprises a touch-sensitive touch panel for performing a selection, means for determining at least one selection area, and a display arranged in connection with the touch panel for showing said at least one selection area, the system also comprising means for establishing two or more touch points on the touch panel, means for determining at least one selection coordinate data by means of these touch points, and comparison means for comparing said at least one selection coordinate data to said at least one selection area.

17. A program, which comprises machine-executable program commands for performing a selection on a touch-sensitive touch panel, for determining at least one selection area, and for showing said at least one selection area on the display, the program also comprising machine-executable program commands for establishing two or more touch points on the touch panel, for determining at least one selection coordinate data by means of these touch points, and for comparing said at least one determined selection coordinate data to said at least one selection area.
